(19) United States
(12) Patent Application Publication
(10) Pub. No.: US 2019/0071201 A1
(43) Pub. Date: Mar. 7, 2019

(54) Three - stage process of baking, infusing, and sealing cakes

(71) Applicant: Alla Levin, Parrish, FL (US)

(72) Inventor: Alla Levin, Parrish, FL (US)

(21) Appl. No.: 15/697,302

(22) Filed: Sep. 6, 2017

(51) Int. Cl. B65B 29/08; A21D 8/06; A21D 13/24; B65B 5/04; A21D 15/00

(52) U.S. Cl. CPC B65B 29/08; A21D 8/06; A21D 15/00; B65B 5/04; A21D 13/24

(57) ABSTRACT

The present invention is a method of preparing an individually portioned, shelf-stable, very moist, soft cake by a three-stage process. Such a prepared cake can be readily stored and/or transported within the jar/container for consumption at a later time and/or remote location.

### BACKGROUND OF THE INVENTION

The present invention relates to the fields of food and food preparation. More particularly, the preparation of desserts. More particularly, the preparation of cakes in jars/containers.

There are no shelf-stable, flavored cake desserts that are individually portioned and prepared in glass jar/container.

### SUMMARY OF THE INVENTION

The present invention is a shelf-stable, very moist, soft cake staying fresh and moist for a prolonged period of time and is obtained by a three-stage process. (1) Placing jar/container on a metal baking sheet with a silicone mat/liner and baking the cake in jars/containers, including but not limited to, glass, plastic, metal, at a high temperature in an oven chamber (killing all bacteria),

(2) soaking/infusing cakes with a mixture of alcohol and flavored sugar syrups/sauces (natural preservatives),
(3) sealing/topping cakes in jars/containers with chocolate and sealing containers with a sealing lid (keeping cakes moist, protecting them from drying out, and from bacteria contaminating the cakes)

The present invention is a method of preparing an individually portioned, shelf-stable, very moist, soft cake by a three-stage process. Such a prepared cake can be readily stored and/or transported within the jar/container for consumption at a later time and/or remote location.

### BRIEF DESCRIPTION OF THE DRAWING

FIG. 1 is a side view illustrating the finished product of the three stage process.

FIG. 2 is a flow-diagram view illustrating the first step of a method of the present invention.

FIG. 3 is a flow-diagram view illustrating the second step of a method of the present invention.

FIG. 4 is a flow-diagram view illustrating the third step of a method of the present invention.

### DETAILED DESCRIPTION OF THE INVENTION

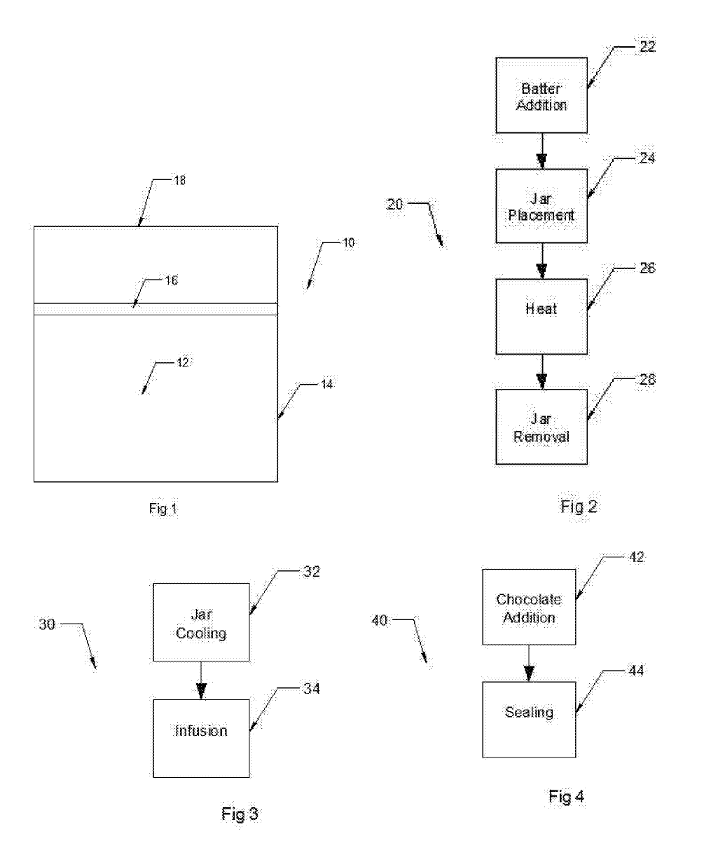

Referring now to the invention in more detail, shown in FIG. 1 is an illustration of a shelf-stable, very moist, soft cake in a jar/container obtained by a three-stage process arrangement 10 produced by the method shown in FIG. 2 through FIG. 4. Said cake in a jar arrangement 10 comprises of an infused, baked cake (12) in a jar/container (14) sealed with chocolate (16) sealed with a sealing lid (18) to prevent contamination. Shown in FIG. 2 is the first flow diagram 20 of a method of baking a cake in a jar/container comprised of the steps of batter addition (22), jar/container placement (24), heating jar/container (26), and removing the jar/container (28).

In the step of batter addition, FIG. 2, comprises filling ⅓ of a jar/container with cake batter (22), placing jar/container on a metal baking sheet with a silicone mat/liner (24), in a preheated oven chamber (26), until the batter is cooked, for 25 to 40 minutes, removing from the oven chamber (28).

In the step of jar cooling (30), FIG. 3, the baked cake in jar/container is allowed to cool to at least ambient room temperature for a sufficient period of time, which is from about 1 to 2 hours (32). The step of infusion (34) comprises of soaking/infusing cakes with a mixture of alcohol and flavored sugar syrups/sauces to a baked cake in a jar/container, left to soak for about 4 to 12 hours, until liquids have reached bottom of the bottom of the container, leaving the top surface of the baked cake free of liquid.

In the step of chocolate addition (40), FIG. 4, said baked/infused cake in jar/container is topped/sealed with heated warm liquid chocolate forming a seal on the top of the cake (42), and is allowed to cool to at least ambient room temperature for a sufficient period of time, which is about 2 to 4 hours. The jar/container is sealed with a sealing lid (44). Such a seal prevents a baked/infused cake from drying out, from the air going into the cake, and from any other contamination; the finished product can be readily stored and/or transported within the jar/container for consumption at a later time and/or remote location.

Less advantageous variations of the present invention are: to not add any of the above mentioned infusion ingredients and/or change the combination of what is used for infusion, which may decrease shelf-life; to replace the chocolate topping with icing, which will produce a product without an air-tight seal; to not let the cake and/or chocolate to cool down to ambient room temperature, which can cause air bubbles to form, reduce shelf-life, and possibly contaminate the cake. Nonetheless, such various production methods are not excluded from broad embodiments of the invention.

The advantages of the shelf-life of the present invention include, without limitation, staying fresh longer than an unpackaged cake. Further, the method of preparation of the present invention, which prevents contamination, is better than baking a cake outside of the jar/container and/or inserting the baked cake into the jar/container. Further, the portion size of the present invention include, without limitation, is better than having a whole cake.

In broad embodiment, the present invention is type of dessert prepared and sealed in a container. [0016] While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. I claim, a method of making a shelf-stable, very moist, soft cake which stays fresh and moist for a prolonged period of time, consisting of a three-stage process wherein the steps are followed in the subsequent order: 1) Placing jar/container on a metal baking sheet with a silicone mat/liner and baking the cake in jars/containers, including but not limited to, glass, plastic, metal, at a high temperature in an over chamber (killing bacteria), 2) Soaking/infusing cakes with a mixture of alcohol and flavored sugar syrups/sauces (natural preservatives), 3) sealing/topping cakes in jars/containers with chocolate and sealing containers with a sealing lid (keeping cakes moist, protecting them from drying out, and from bacteria contaminating the cakes) in order to produce a unique product as there are no shelf-stable flavored cake desserts that are individually portioned and prepared in a glass jar/container.
